(19) United States
(12) Patent Application Publication
(10) Pub. No.: US 2019/0265710 A1
(43) Pub. Date: Aug. 29, 2019

(54) VEHICLE CONTROL DEVICE, VEHICLE CONTROL SYSTEM, VEHICLE CONTROL METHOD, AND VEHICLE CONTROL PROGRAM

(71) Applicant: HONDA MOTOR CO., LTD., Minato-ku, Tokyo (JP)

(72) Inventors: Kazuyuki Kaneko, Wako-shi (JP); Shogo Akaba, Wako-shi (JP); Genta Boda, Wako-shi (JP)

(21) Appl. No.: 16/346,130

(22) PCT Filed: Nov. 11, 2016
(86) PCT No.: PCT/JP2016/083508

§ 371 Date: Apr. 30, 2019

(51) Int. Cl. G05D 1/02; G05D 1/00; B60W 40/08

(52) U.S. Cl. CPC G05D 1/0214; G05D 1/0022; B60W 2050/0071; G05D 1/0061; B60R 2300/8006; B60W 40/08

(57) ABSTRACT

A vehicle control device includes: an acquisitor configured to acquire a situation outside a vehicle; a driving operator configured to execute an operation for manual driving by an occupant of the vehicle; a detector configured to detect a state of the occupant of the vehicle; a manual driving controller configured to execute the manual driving to cause the vehicle to travel based on an operation received by the driving operator; a communicator configured to communicate with a facility outside the vehicle and transmit the situation outside the vehicle acquired by the acquisitor to the facility outside the vehicle; a remotely controlled driving controller configured to execute remotely controlled driving to cause the vehicle to travel based on control information received from the facility outside the vehicle; and a switching controller configured to switch from the remotely controlled driving to the manual driving when the remotely controlled driving is executed by the remotely controlled driving controller and a state of the occupant of the vehicle detected by the detector satisfies a predetermined condition.

### TECHNICAL FIELD

The present invention relates to a vehicle control device, a vehicle control system, a vehicle control method, and a storage medium.

### BACKGROUND ART

In recent years, studies on automated driving for automatically executing acceleration or deceleration and steering have been in progress. In association with this, a technology for executing heteronomy-oriented automated driving by causing a vehicle to communicate with an external device and executing a remote operation when it is determined that autonomy-oriented automated driving is not executable has been disclosed (see Patent Literature 1). A technology for executing a remote operation by detecting a travel state of a vehicle through various sensors, sending a detected signal to a control center through a communication device or the like, allowing a remote operator to remotely operate the vehicle, and sending an instruction signal for executing the remote operation to an in-vehicle remote adjustment device is disclosed (see Patent Literature 2).

### CITATION LIST

### Patent Literature

[Patent Literature 1]

PCT International Publication No. WO2016/038931
[Patent Literature 2]

Japanese Unexamined Patent Application, First Publication No. 2004-295360

### SUMMARY OF INVENTION

### Technical Problem

However, in the technologies disclosed in Patent Literatures 1 and 2, when remote driving is executed, switching the remote driving to manual driving is not considered. When the remote driving is switched to the manual driving, there is a possibility of a burden on an occupant of a vehicle increasing.

The present invention is devised in view of such circumstances and one object of the present invention is to provide a vehicle control device, a vehicle control system, a vehicle control method, and a vehicle control program capable of suppressing a burden on an occupant of a vehicle.

### Solution to Problem

(1): A vehicle control device including: an acquisitor configured to acquire a situation outside a vehicle; a driving operator configured to execute an operation for manual driving by an occupant of the vehicle; a detector configured to detect a state of the occupant of the vehicle; a manual driving controller configured to execute the manual driving to cause the vehicle to travel based on an operation received by the driving operator; a communicator configured to communicate with a facility outside the vehicle and transmit the situation outside the vehicle acquired by the acquisitor to the facility outside the vehicle; a remotely controlled driving controller configured to execute remotely controlled driving to cause the vehicle to travel based on control information received from the facility outside the vehicle; and a switching controller configured to switch from the remotely controlled driving to the manual driving when the remotely controlled driving is executed by the remotely controlled driving controller and a state of the occupant of the vehicle detected by the detector satisfies a predetermined condition.

(2): The vehicle control system according to (1) may further include an automated driving control unit configured to execute automated driving to automatically control at least one of acceleration or deceleration and steering of the vehicle. When the remotely controlled driving is ended by the remotely controlled driving controller and the occupant state of the vehicle detected by the detector does not satisfy the predetermined condition, the automated driving control unit may execute the automated driving.

(3): The vehicle control system according to (1), the predetermined condition may be a condition that the occupant state of the vehicle is a state in which the manual driving is executable.

(4): The vehicle control system according to (3), the detector may acquire an image obtained by imaging the occupant of the vehicle. The switching controller may determine whether the occupant state of the vehicle is a state in which the manual driving is executable based on the image obtained by imaging the occupant of the vehicle.

(5): The vehicle control system according to (3), the detector may acquire an operation state in the driving operator. Based on the operation state in the driving operator, the switching controller may determine whether the manual driving is executable based on an operation of the occupant of the vehicle.

(6): The vehicle control system according to (1) may further include a suggestion unit configured to suggest information; a notification unit configured to cause the suggestion unit to suggest information indicating that the vehicle is executing the remotely controlled driving when the remotely controlled driving controller executes the remotely controlled driving and cause the suggestion unit to suggest information for checking switching from the remotely controlled driving to the manual driving when the switching from the remotely controlled driving to the manual driving is necessary; and an input unit configured to receive an input operation by the occupant of the vehicle. The switching controller determines that the occupant state of the vehicle satisfies the predetermined condition when the input unit receives an operation of checking the switching from the remotely controlled driving to the manual driving.

(7): The vehicle control system according to (1), the switching controller may set a timing of the switching from the remotely controlled driving to the manual driving. The vehicle control device may further include: a suggestion unit configured to suggest information; and a notification unit configured to cause the suggestion unit to suggest a period until the timing arrives.

(8): The vehicle control system according to (7), the switching controller may cause the communicator to transmit information indicating the timing or information indicating a period until the timing arrives to the facility outside the vehicle.

(9): The vehicle control system according to (1), the remotely controlled driving controller may reduce a control amount indicated by the control information gradually during a period until the timing arrives.

(10): A vehicle control system includes: the vehicle control device according to (1); and the facility outside the vehicle.

(11): A vehicle control method causing a computer to: acquire a situation outside a vehicle; transmit the acquired situation outside the vehicle to a facility outside the vehicle; execute remotely controlled driving to cause the vehicle to travel based on control information received from the facility outside the vehicle; detect a state of an occupant of the vehicle when the remotely controlled driving is executed; and execute manual driving to cause the vehicle to travel based on an operation received by a driving operator in which an operation is executed for the manual driving by the occupant of the vehicle from the remotely controlled driving when the detected occupant state of the vehicle satisfies a predetermined condition.

(12): A computer-readable non-transitory storage medium storing a vehicle control program causing a computer to: acquire a situation outside a vehicle; transmit the acquired situation outside the vehicle to a facility outside the vehicle; execute remotely controlled driving to cause the vehicle to travel based on control information received from the facility outside the vehicle; detect a state of an occupant of the vehicle when the remotely controlled driving is executed; and execute manual driving to cause the vehicle to travel based on an operation received by a driving operator in which an operation is executed for the manual driving by the occupant of the vehicle from the remotely controlled driving when the detected occupant state of the vehicle satisfies a predetermined condition.

### Advantageous Effects of Invention

According to (1), (2), (10), (11), and (12), when the remotely controlled driving is executed and the occupant state of the vehicle satisfies the predetermined condition, the switching from the remotely controlled driving to the manual driving is performed. Therefore, it is possible to suppress a burden on the occupant of the vehicle M.

According to (3) to (5), since a state in which the manual driving is possible is determined based on an operation of the occupant of the vehicle and switching from the remotely controlled driving to the manual driving is performed, it is possible to suppress the switching from the remotely controlled driving to the manual driving in a state in which the manual driving is difficult. Thus, it is possible to reduce a burden on the occupant of the vehicle.

According to (6), the occupant of the vehicle can check the switching from the remotely controlled driving to the manual driving.

According to (7), since the period until the switching timing arrives is suggested, the switching from the remotely controlled driving to the manual driving can be smoothly executed. Therefore, it is possible to reduce a burden on the occupant of the vehicle.

According to (8), since the information indicating the switching timing or the information indicating the period until the switching timing arrives is transmitted to the facility outside the vehicle, the switching from the remotely controlled driving to the manual driving can be smoothly executed. Thus, it is possible to reduce a burden on the occupant of the vehicle.

According to (9), since a control amount indicating the control information during the period until the switching timing arrives is reduced gradually, the occupant of the vehicle is caused to execute a driving operation during the switching from the remotely controlled driving to the manual driving. Thus, according to the vehicle control system 1, when the switching timing arrives, it is possible to avoid abrupt end of travel of the vehicle M based on the control information. Thus, it is possible to reduce a burden on the occupant of the vehicle M.

### BRIEF DESCRIPTION OF DRAWINGS

FIG. 1 is a conceptual diagram illustrating a vehicle control system.

FIG. 2 is a diagram illustrating an example of a configuration mounted in a vehicle M.

FIG. 3 is a diagram illustrating an aspect in which a target trajectory is generated based on a recommended lane.

FIG. 4 is a diagram illustrating a device configuration in a remote operation management facility.

FIG. 5 is a diagram illustrating an example of content of a remote operator list.

FIG. 6 is a diagram schematically illustrating a configuration of a remote operation device.

FIG. 7 is a flowchart illustrating an example of a flow of a process of switching from remotely controlled driving to manual driving.

FIG. 8 is a diagram illustrating an example of a screen for requesting an occupant to prepare to start the manual driving.

FIG. 9 is a diagram illustrating an example of a switching check screen.

FIG. 10 is a diagram illustrating an example of a screen on which an occupant of a vehicle M is notified of a remaining time until a switching timing.

FIG. 11 is a diagram illustrating an example of a screen on which a remote operator is notified of a remaining time until the switching timing.

FIG. 12 is a diagram illustrating an example of a temporal change of a ratio of a control amount based on the manual driving to a control amount based on remote driving.

FIG. 13 is a flowchart illustrating an example of a flow of a process of ending execution of the remote driving and starting execution of the automated driving or the manual driving.

FIG. 14 is a diagram conceptually illustrating a form in which a remote operation is executed by an occupant of a vehicle.

FIG. 15 is a diagram illustrating an example of a configuration mounted in the vehicle M executing the remote operation.

### DESCRIPTION OF EMBODIMENTS

Hereinafter, embodiments of a vehicle control device, a vehicle control system, a vehicle control method, and a storage medium according to the present invention will be described with reference to the drawings.

### First Embodiment

### [System Configuration]

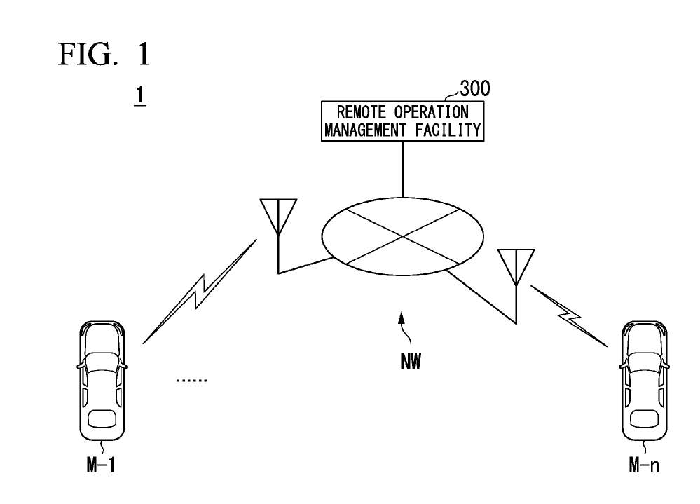

FIG. 1 is a conceptual diagram illustrating a vehicle control system 1. The vehicle control system 1 is realized when a plurality of vehicles M-1 to M-n (where n is any natural number) and a remote operation management facility 300 communicate via a network NW. Hereinafter, when vehicles are not distinguished from each other, the vehicles are referred to as vehicles M. The vehicle M is, for example, a vehicle such as a two-wheeled vehicle, a three-wheeled vehicle, or a four-wheeled vehicle. A driving source of the vehicle M includes an internal combustion engine such as a diesel engine or a gasoline engine, an electric motor, and a combination thereof. The electric motor operates using power generated by a power generator connected to the internal combustion engine or power discharged from a secondary cell or a fuel cell. The vehicle M is a vehicle capable of executing automated driving to automatically controlling at least one of acceleration or deceleration and steering. The network NW includes a base station which is an interface of wireless communication, a wide area network (WAN), a local area network (LAN), the Internet, and a dedicated line.

In the vehicle control system 1, a remote operation request is transmitted from the vehicle M to the remote operation management facility 300 or is transmitted from a certain vehicle M to another vehicle M, and a remote operation of the vehicle M is executed in response to the remote operation request.

### [Vehicle Configuration]

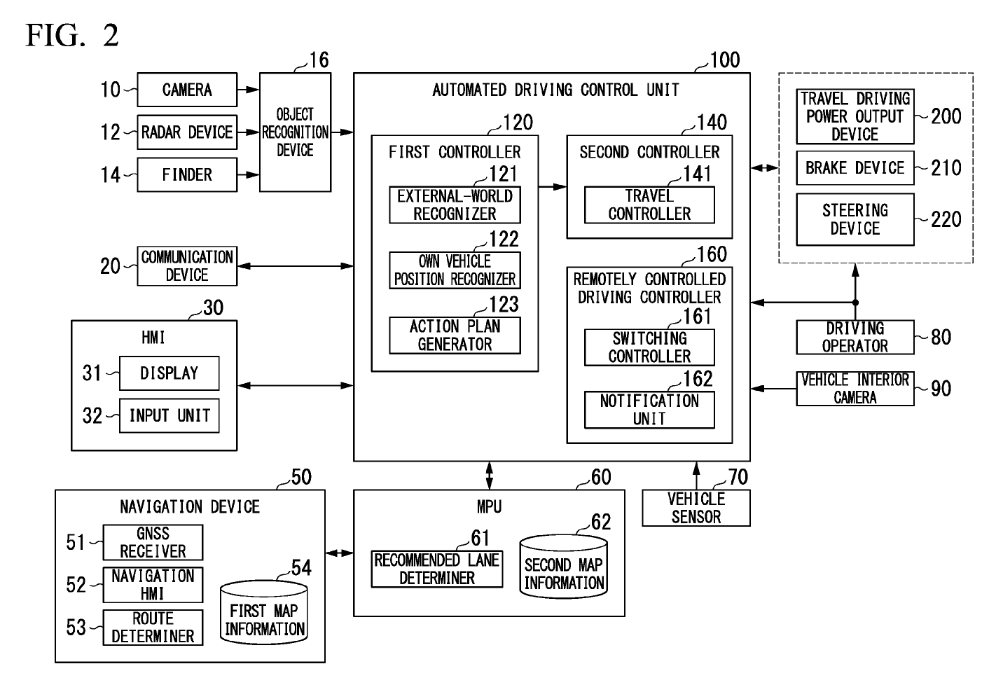

Next, a configuration mounted in the vehicle M will be described. FIG. 2 is a diagram illustrating an example of a configuration mounted in the vehicle M. For example, a camera 10, a radar device 12, a finder 14, an object recognition device 16, a communication device 20, a human machine interface (HMI) 30, a navigation device 50, a micro processing unit (MPU) 60, a vehicle sensor 70, a driving operator 80, a vehicle interior camera 90, an automated driving control unit 100, a travel driving power output device 200, a brake device 210, and a steering device 220 are mounted on the vehicle M. The devices and units are connected to each other via a multiplex communication line such as a controller area network (CAN) communication line, a serial communication line, or a wireless communication network. The configuration illustrated in FIG. 2 is merely exemplary, a part of the configuration may be omitted, and another configuration may be further added. In the configuration illustrated in FIG. 2, a device that includes at least the camera 10, the communication device 20, the driving operator 80, a first controller 120, a second controller 140, and a remotely controlled driving controller 160 is an example of a “vehicle control device.”

The camera 10 is, for example, a digital camera that uses a solid-state image sensor such as a charged coupled device (CCD) or a complementary metal oxide semiconductor (CMOS). The single camera 10 or the plurality of cameras 10 are mounted on any portion of the vehicle M. In the case of forward imaging, the camera 10 is mounted on an upper portion of a front windshield, a rear surface of a rearview mirror, or the like. For example, the camera 10 repeatedly images the periphery of the own vehicle M periodically. The camera 10 may be a stereo camera.

The radar device 12 radiates radio waves such as millimeter waves to the periphery of the own vehicle M and detects radio waves (reflected waves) reflected from an object to detect at least a position (a distance and an azimuth) of the object. The single radar device 12 or the plurality of radar devices 12 are mounted on any portion of the own vehicle M. The radar device 12 may detect a position and a speed of an object in conformity with a frequency modulated continuous wave (FMCW) scheme.

The finder 14 is a light detection and ranging or a laser imaging detection and ranging (LIDAR) finder that measures scattered light of radiated light and detects a distance to a target. The single finder 14 or the plurality of finders 14 are mounted on any portion of the own vehicle M.

The object recognition device 16 executes a sensor fusion process on detection results from some or all of the camera 10, the radar device 12, and the finder 14 and recognizes a position, a type, a speed, and the like of an object. The object recognition device 16 outputs a recognition result to the automated driving control unit 100.

The communication device 20 communicates with other vehicles around the own vehicle M using, for example, a cellular network, a Wi-Fi network, Bluetooth (registered trademark), dedicated short range communication (DSRC), or the like or communicates with an external device such as the remote operation management facility 300 via a wireless base station.

The HMI 30 includes a display 31 that suggests various types of information to occupants of the own vehicle M and an input unit 32 that receives input operations by the occupants. The HMI 30 includes various display devices, a speaker, a buzzer, a touch panel, a switch, and a key.

The navigation device 50 includes, for example, a global navigation satellite system (GNSS) receiver 51, a navigation HMI 52, and a route determiner 53 and retains first map information 54 in a storage device such as a hard disk drive (HDD) or a flash memory. The GNSS receiver specifies a position of the own vehicle M based on signals received from GNSS satellites. The position of the own vehicle M may be specified or complemented by an inertial navigation system (INS) using an output of the vehicle sensor 70. The navigation HMI 52 includes a display device, a speaker, a touch panel, and a key. The navigation HMI 52 may be partially or entirely common to the above-described HMI 30. The route determiner 53 decides, for example, a route from a position of the own vehicle M specified by the GNSS receiver 51 (or any input position) to a destination input by an occupant using the navigation HMI 52 with reference to the first map information 54. The first map information 54 is, for example, information in which a road form is expressed by links indicating roads and nodes connected by the links. The first map information 54 may include curvatures of roads and point of interest (POI) information. The route decided by the route determiner 53 is output to the MPU 60. The navigation device 50 may execute route guidance using the navigation HMI 52 based on the route decided by the route determiner 53. The navigation device 50 may be realized by, for example, a function of a terminal device such as a smartphone or a tablet terminal possessed by a user. The navigation device 50 may transmit a current position and a destination to a navigation server via the communication device 20 to acquire a route replied from the navigation server.

The MPU 60 functions as, for example, a recommended lane determiner 61 and retains second map information 62 in a storage device such as an HDD or a flash memory. The recommended lane determiner 61 divides a route provided from the navigation device 50 into a plurality of blocks (for example, divides the route in a vehicle movement direction for each 100 [m]) and decides a recommended lane for each block with reference to the second map information 62. The recommended lane determiner 61 decides in which lane the vehicle travels from the left. When there is a branching spot a joining spot, or the like on the route, the recommended lane determiner 61 decides a recommended lane so that the own vehicle M can travel along a reasonable travel route for moving to a branching destination.

The second map information 62 is map information with higher precision than the first map information 54. The second map information 62 includes, for example, information regarding the middles of lanes or information regarding boundaries of lanes. The second map information 62 may include road information, traffic regulation information, address information (address and postal number), facility information, and telephone number information. The road information includes information indicating kinds of roads such as expressways, roll roads, national ways, or prefecture roads and information such as the number of lanes of a road, the width of each lane, the gradients of roads, the positions of roads (3-dimensional coordinates including longitude, latitude, and height), curvatures of curves of lanes, positions of joining and branching points of lanes, and signs installed on roads. The second map information 62 may be updated frequently when the communication device 20 are used to access other devices.

The vehicle sensor 70 includes a vehicle speed sensor that detects a speed of the own vehicle M, an acceleration sensor that detects acceleration, a yaw rate sensor that detects an angular velocity around a vertical axis, and an azimuth sensor that detects a direction of the own vehicle M.

The driving operator 80 includes, for example, an accelerator pedal, a brake pedal, a shift lever, a steering wheel, and other operators. A sensor that detects whether there is an operation or an operation amount is mounted on the driving operator 80 and a detection result is output to the automated driving control unit 100 or some or all of the travel driving power output device 200, the brake device 210, and the steering device 220. The driving operator 80 includes a touch sensor that detects contact or non-contact with the driving operator 80 in addition to a sensor that detects presence or absence of an operation. The touch sensor is, for example, a sensor that is contained in a gripping portion of the steering wheel. The touch sensor detects a touch of a hand of an occupant of the vehicle M on the steering wheel and outputs a detection result to the automated driving control unit 100.

The vehicle interior camera 90 images the upper half body of an occupant sitting on a driving seat centering on his or her face. An image captured by the vehicle interior camera 90 is output to the automated driving control unit 100.

The automated driving control unit 100 includes, for example, a first controller 120, a second controller 140, and a remotely controlled driving controller 160. Each of the first controller 120, the second controller 140, and the remotely controlled driving controller 160 is realized, for example, by causing a processor such as a central processing unit (CPU) to execute a program (software). Some or all of the function units of the first controller 120, the second controller 140, and the remotely controlled driving controller 160 to be described below may be realized by hardware such as a large scale integration (LSI), an application specific integrated circuit (ASIC), or a field-programmable gate array (FPGA), or may be realized by software and hardware in cooperation.

The first controller 120 includes, for example, an external-world recognizer 121, an own vehicle position recognizer 122, and an action plan generator 123.

The external-world recognizer 121 recognizes states such as positions of peripheral vehicles and speeds, acceleration, or the like thereof based on information input from the camera 10, the radar device 12, and the finder 14 via the object recognition device 16. The positions of the peripheral vehicles may be represented as representative points such as centers, corners, or the like of the peripheral vehicles or may be represented as regions expressed by contours of the peripheral vehicles. The “states” of the peripheral vehicles may include acceleration or jerk of the peripheral vehicles or “action states” (for example, whether the peripheral vehicles are changing their lanes or are attempting to change their lanes). The external-world recognizer 121 may recognize guardrails, electric poles, parked vehicles, pedestrians, and other objects in addition to the peripheral vehicles.

The own vehicle position recognizer 122 recognizes, for example, a lane along which the own vehicle M is traveling (a travel lane) and a relative position and an attitude of the own vehicle M with respect to the travel lane. The own vehicle position recognizer 122 recognizes, for example, the travel lane by comparing patterns of road mark lines (for example, arrangement of continuous lines and broken lines) obtained from the second map information 62 with patterns of road mark lines around the own vehicle M recognized from images captured by the camera 10. In this recognition, the position of the own vehicle M acquired from the navigation device 50 or a process result by INS may be added.

The action plan generator 123 decides events which are sequentially executed in automated driving so that the own vehicle M travels along the recommended lane decided by the recommended lane determiner 61 and peripheral situations of the own vehicle M can be handled. As the events, for example, there are a constant speed traveling event for traveling at a constant speed along the same travel lane, a tracking travel event for tracking a front traveling vehicle, a lane changing event, a joining event, a branching event, an emergent stopping event, and a handover event for ending automated driving to switch to manual driving. While such an event is executing, an action for avoidance is planned in some cases on the basis of a peripheral situation (presence of a peripheral vehicle or a pedestrian, contraction of a lane due to road construction, or the like) of the own vehicle M.

The action plan generator 123 generates a target trajectory along which the own vehicle M travels in future. The target trajectory includes, for example, a speed component. For example, the target trajectory is generated as a set of target spots (trajectory points) at which the own vehicle arrives at reference times when the plurality of future reference times are set for each predetermined sampling time (for example, about 0 decimal point [sec]). Therefore, when a width between the trajectory points is broad, the width indicates a section between the trajectory points in which the own vehicle is traveling at a high speed.

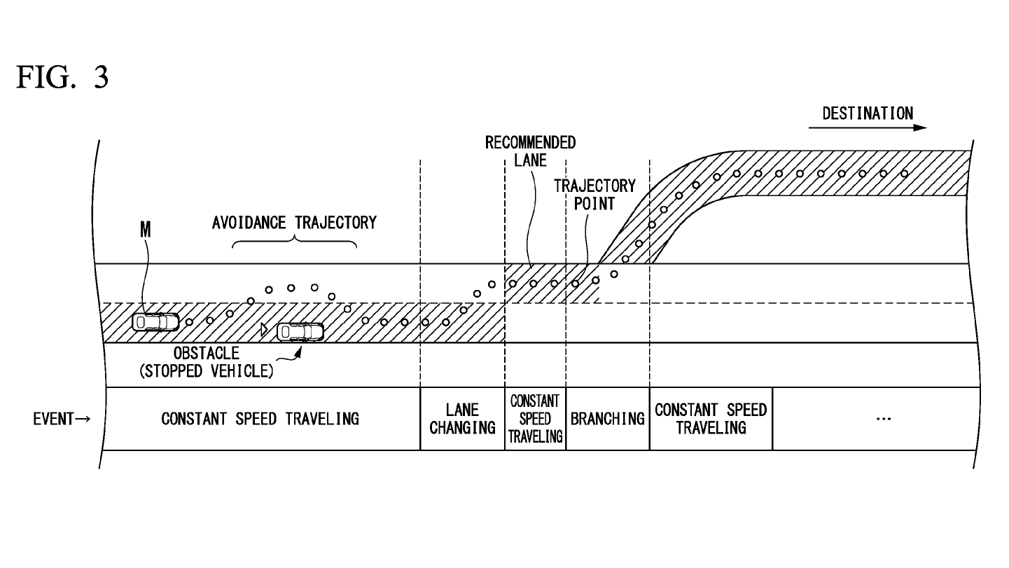

FIG. 3 is a diagram illustrating an aspect in which a target trajectory is generated based on a recommended lane. As illustrated, the recommended lane is set so that a condition of traveling along a route to a designation is good. The action plan generator 123 activates a lane changing event, a branching event, a joining event, or the like when the own vehicle arrives at a front of a predetermined distance of a switching spot of the recommended lane (which may be decided in accordance with a type of event). When it is necessary to avoid an obstacle while each event is executed, an avoidance trajectory is generated, as illustrated.

The action plan generator 123 generates, for example, a plurality of target trajectory candidates and selects an optimum target trajectory at that time on the basis of a viewpoint for safety and efficiency.

The second controller 140 includes a travel controller 141. The travel controller 141 controls the travel driving power output device 200, the brake device 210, and the steering device 220 so that the vehicle M passes along a target trajectory generated by the action plan generator 123 at a scheduled time.

The remotely controlled driving controller 160 transmits a remote operation request using the communication device 20 and executes remotely controlled driving to automatically control at least one of steering and an accelerated or decelerated speed of the own vehicle M based on the control information received from the remote operation management facility 300. The remotely controlled driving controller 160 includes a switching controller 161 and a notification unit 162. The switching controller 161 executes control such that the remotely controlled driving ends from the state in which the remotely controlled driving is executed and is switched to manual driving. The switching controller 161 executes control such that the remotely controlled driving starts from a state in which the manual driving is executed. The switching controller 161 may execute control such that the remotely controlled driving starts from a state in which the automated driving is executed or may end the remotely controlled driving from the state in which the remotely controlled driving is executed and start the automated driving. The notification unit 162 uses the display 31 to suggest an image indicating whether the remotely controlled driving or the manual driving is executed. The notification unit 162 suggests an image for checking that the remotely controlled driving is switched to the manual driving.

The travel driving power output device 200 outputs travel driving power (torque) for traveling the vehicle to a driving wheel. The travel driving power output device 200 includes, for example, a combination of an internal combustion engine, an electric motor and a transmission, and an electronic control unit (ECU) controlling these units. The ECU controls the foregoing configuration in accordance with information input from the automated driving control unit 100 or information input from the driving operator 80.

The brake device 210 includes, for example, a brake caliper, a cylinder that transmits a hydraulic pressure to the brake caliper, an electronic motor that generates a hydraulic pressure to the cylinder, and a brake ECU. The brake ECU controls the electric motor in accordance with information input from the automated driving control unit 100 or information input from the driving operator 80 such that a brake torque in accordance with a brake operation is output to each wheel. The brake device 210 may include a mechanism that transmits a hydraulic pressure generated in response to an operation of the brake pedal included in the driving operator 80 to the cylinder via a master cylinder as a backup. The brake device 210 is not limited to the above-described configuration and may be an electronic control type hydraulic brake device that controls an actuator in accordance with information input from the travel controller 141 such that a hydraulic pressure of the master cylinder is transmitted to the cylinder.

The steering device 220 includes, for example, a steering ECU and an electric motor. The electric motor works a force to, for example, a rack and pinion mechanism to change a direction of a steering wheel. The steering ECU drives the electric motor to change the direction of the steering wheel in accordance with information input from the automated driving control unit 100 or information input from the driving operator 80.

### [Remote Operation Management Facility 300]

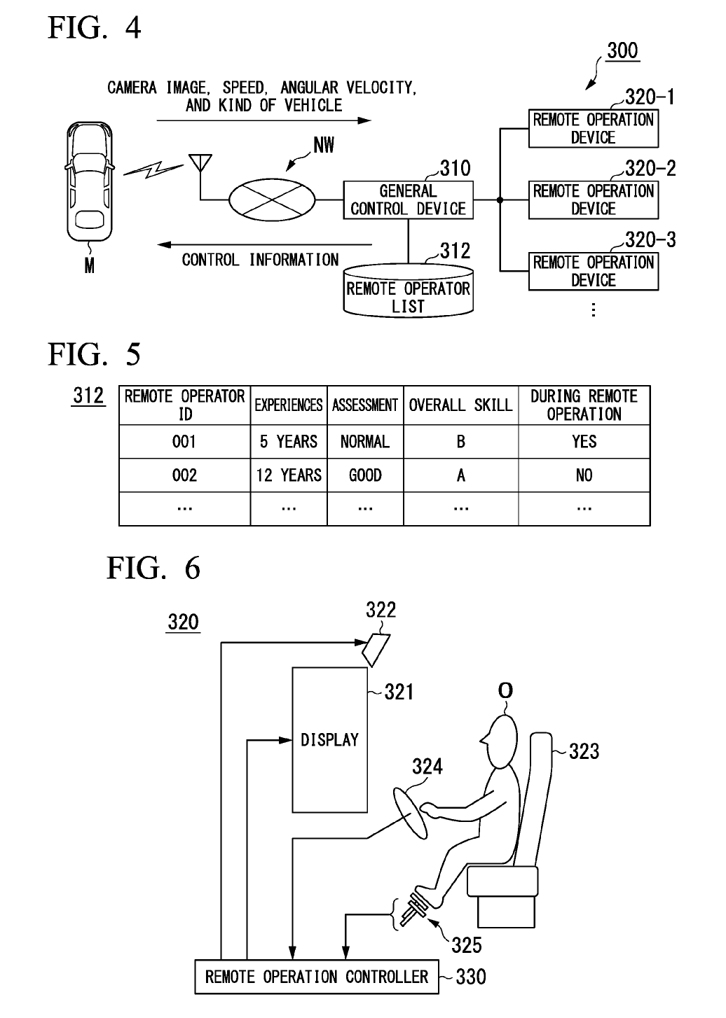

Hereinafter, a facility which executes a remote operation and is outside of a vehicle will be described. FIG. 4 is a diagram illustrating a device configuration in a remote operation management facility 300. As illustrated, a general control device 310 and a plurality of remote operation devices 320-1, 320-2, 320-3, and the like communicating with the vehicle M (remotely controlled vehicle) via a network NW are provided in the remote operation management facility 300. Hereinafter, when the remote operation devices are not distinguished from each other, the remote operation devices are simply referred to as the remote operation devices 320.

In each remote operation device 320, a remote operator sits and waits for a remote operation request. The general control device 310 transmits information received from the vehicle M to the remote operation device 320 so that the remote operator can execute a remote operation. The information received from the vehicle M is information indicating a vehicle situation such as an image, a sound, a speed, an angular velocity, and a kind of vehicle acquired by devices such as a camera and the like mounted on the vehicle M. The general control device 310 generates control information based on a driving operation received by one remote operation device 320 and transmits the generated control information to the vehicle M.

The general control device 310 of the remote operation management facility 300 selects a remote operator matching the information received from the vehicle M with reference to a remote operator list 312 and causes the remote operation device 320 operated by the selected remote operator to execute a remote operation. FIG. 5 is a diagram illustrating an example of content of the remote operator list 312. In the remote operator list 312, for example, information such as years of experience on a remote operation, recent assessment of a remote operation, and overall skill obtained by assessing them generally, and a flag indicating whether the remote operation is being executed is stored in association with a remote operator ID which is identification information of the remote operator. The general control device 310 selects one remote operator based on the assessment or the overall skill among the remote operators that are not executing remote operations. The general control device 310 transmits information received from the vehicle M to the remote operation device 320 operated by the selected remote operator and transmits the control information received from the remote operation device 320 to the vehicle M. Thus, the general control device 310 and the remote operation device 320 execute remote driving.

The general control device 310 generates control information for executing the remote driving and transmits the generated control information to the vehicle M when a predetermined condition is satisfied. Therefore, the general control device 310 selects one remote operator among the plurality of remote operators registered in the remote operator list 312 with reference to the remote operator list 312. The general control device 310 transmits control information generated by the remote operation device 320 operated by the selected remote operator to the vehicle M.

FIG. 6 is a diagram schematically illustrating a configuration of the remote operation devices 320. The remote operation devices 320 include, for example, a display 321, a speaker 322, a seat 323, a steering wheel 324, pedals 325 such as an accelerator pedal and a brake pedal, and a remote operation controller 330.

The display 321 displays an image captured by a camera of the vehicle M, a speed of the vehicle M, an engine speed, and the like. The display 321 may be a head mount display (HMD). The speaker 322 issues a warning sound in response to an approach of an obstacle recognized by the object recognition device 16 of the vehicle M to the vehicle M. A remote operator O sits in the seat 323. The remote operator O executes driving operations for the driving operators such as the steering wheel 324 and pedals 325. Operation amounts in the driving operators are detected by sensors (not illustrated) and are output to the remote operation controller 330. The driving operators may be different types of driving operators such as joysticks.

The remote operation controller 330 generates control information to be transmitted to the vehicle M based on the operation amounts input by the driving operators. The remote operation controller 330 transmits the generated control information to the general control device 310. The general control device 310 transmits control information generated by the selected remote operation device 320 among the plurality of pieces of control information generated by the plurality of remote operation devices 320 to the vehicle M. In the driving operator, a reaction force output device that causes a reaction force generated in accordance with an operation amount to act is supplemented. To decide the reaction force accurately, it is good to supply information such as a speed or an angular speed from the vehicle M to the remote operation device 320.

The control information transmitted to the vehicle M may be operation amounts for the steering wheel 324 or the pedals 325 or may be control amounts which are calculated based on operation amounts changed on the basis of a vehicle speed or a turning angle of the vehicle M at that time and is to be provided to the travel driving power output device 200, the brake device 210, or the steering device 220 (for example, the degree of throttle opening, a brake torque, an output torque of an assist motor of the steering device 220, or the like).

[Switching from Remotely Controlled Driving to Manual Driving]

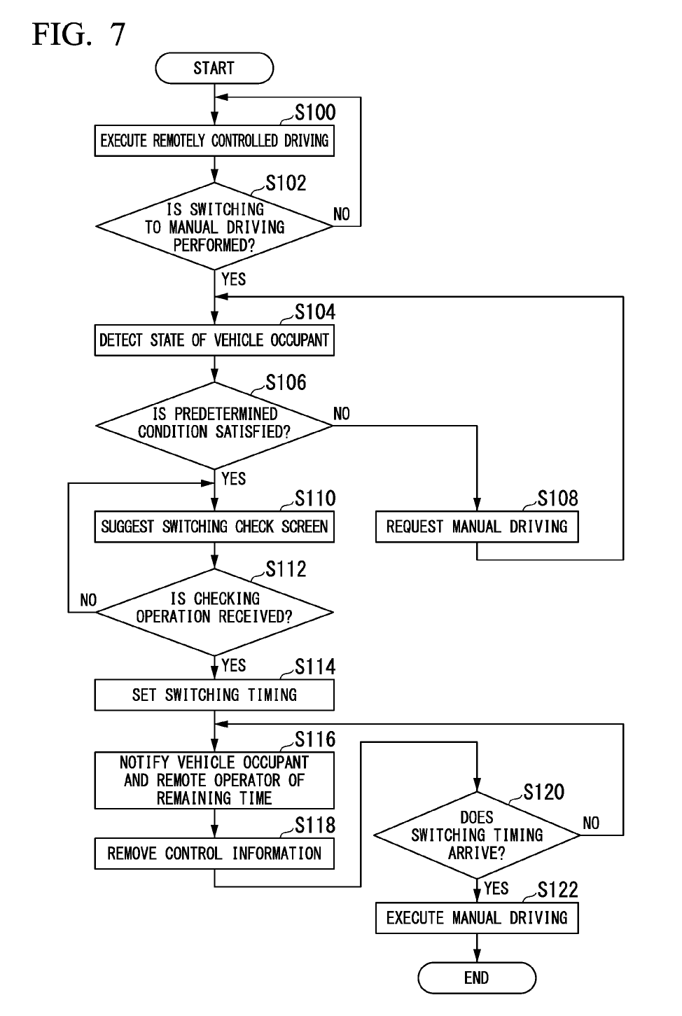

Hereinafter, a process of ending execution of remotely controlled driving and starting manual driving in a state in which the remotely controlled driving is executed will be described. FIG. 7 is a flowchart illustrating an example of a flow of a process of switching from remotely controlled driving to manual driving. The automated driving control unit 100 executes remotely controlled driving through the remotely controlled driving controller 160 (step S100). The switching controller 161 determines whether to switch to the manual driving, for example, for each predetermined period while the remotely controlled driving is executed (step S102). For example, when a communication state between the communication device 20 and the remote operation management facility 300 is disconnected and thus a period in which the control information is not transmitted from the remote operation management facility 300 exceeds a predetermined period, the switching controller 161 determines to switch to the manual driving.

When the switching controller 161 determines not to switch to the manual driving, the switching controller 161 continues to execute the remotely controlled driving. The switching controller 161 detects a state of an occupant of the vehicle M in the case of the switching to the manual driving (step S104). For example, the switching controller 161 detects a state of the occupant of the vehicle M such as a sitting position of the occupant of the vehicle M and an attitude or the like of the occupant of the vehicle M based on an image captured by the vehicle interior camera 90. For example, the switching controller 161 acquires an operation state in the driving operator 80 and detects a state of the occupant of the vehicle M based on an operation state such as whether a hand of the occupant of the vehicle M grips the steering wheel.

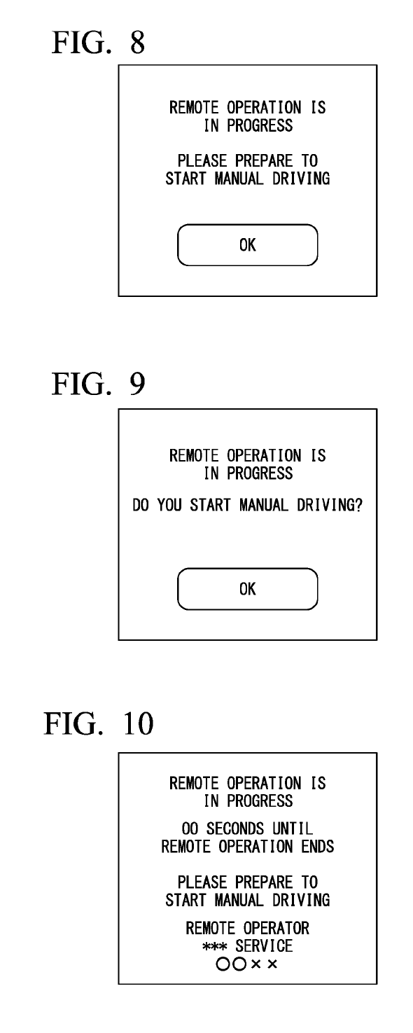

Subsequently, the switching controller 161 determines whether the occupant state of the vehicle M detected in step S104 satisfies a predetermined condition (step S106). The predetermined condition refers to a state in which the manual driving is possible based on an operation of the occupant of the vehicle M. When the predetermined condition is not satisfied, the switching controller 161 requests the manual driving from the occupant of the vehicle M (step S108). For example, the notification unit 162 suggests an image for requesting the occupant to prepare for the manual driving through the display 31. FIG. 8 is a diagram illustrating an example of a screen for requesting the occupant to prepare to start the manual driving. The screen includes a message indicating that the remote driving is in progress, a message for prompting the occupant to prepare to start the manual driving, and a button for receiving a checking operation.

The switching controller 161 determines that the predetermined condition is satisfied based on an image captured by the vehicle interior camera 90 when the occupant of the vehicle M sits in a driving seat and an attitude of the occupant of the vehicle M is an attitude in which the driving operators 80 such as the steering wheel, the acceleration pedal, and the brake pedal can be operated. The switching controller 161 determines that the predetermined condition is satisfied further when the hand of the occupant of the vehicle M grips the steering wheel and the acceleration pedal or the brake pedal can be operated. The notification unit 162 suggests a switching check screen using the HMI 30 when the occupant state of the vehicle M satisfies the predetermined condition (step S110). FIG. 9 is a diagram illustrating an example of the switching check screen. The switching check screen includes a message indicating that the remote driving is in progress, a message for checking that the manual driving is started, and a button for receiving a checking operation.

The switching controller 161 determines whether a checking operation for the start of the manual driving is received (step S112). When the checking operation is received, a switching timing from the remote driving to the manual driving is set (step S114). That is, when an operation of checking the switching from the remotely controlled driving to the manual driving is received, the switching controller 161 determines that the occupant state of the vehicle M satisfies the predetermined condition. For example, the switching controller 161 sets a timing after a predetermined period from a time at which the checking operation is received as the switching timing. The predetermined period is, for example, several minutes. The switching controller 161 continues the suggestion of the switching check screen when the checking operation is not received.

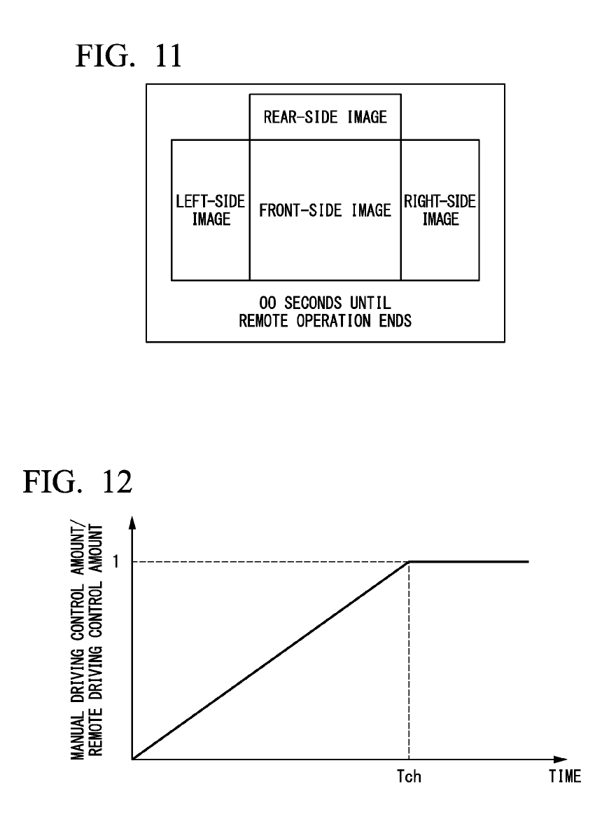

The notification unit 162 notifies the occupant of the vehicle M and the remote operator of a remaining time until the switching timing (step S116). FIG. 10 is a diagram illustrating an example of a screen that notifies the occupant of the vehicle M of the remaining time until the switching timing. The screen includes a message indicating that the remote driving is in progress, a message for prompting the occupant to prepare to start the manual driving, and a message indicating the remaining time until the remote operation ends. FIG. 11 is a diagram illustrating an example of a screen that notifies a remote operator of the remaining time until the switching timing. The screen includes a front-side image, a right-side image, a left-side image, a rear-side image, and a message indicating a remaining time until the remote operation ends which are transmitted from the vehicle M to the remote operation management facility 300. The notification unit 162 causes, for example, the message indicating the remaining time until the remote operation ends to be displayed by transmitting information indicating the switching timing or information indicating a period until the switching timing arrives to the remote operation management facility 300. The switching controller 161 may notify of the remaining time until the switching timing by a sound.

Subsequently, the switching controller 161 gradually changes the control information transmitted to the remote operation management facility 300 (step S118). The gradual change in the control information is equivalent to a reduction of an operation amount or a control amount indicated by the control information gradually during a period until the switching timing arrives. FIG. 12 is a diagram illustrating an example of a temporal change of a ratio of a control amount based on the manual driving to a control amount based on the remote driving. The switching controller 161 linearly increases the ratio of the control amount based on the manual driving to the control amount based on the remote driving during a period until a time tch equivalent to the switching timing comes. Thus, the switching controller 161 can instruct the occupant of the vehicle M that the remote driving ends and the manual driving starts by gradually reflecting the driving operation received by the driving operators 80 in a travel state of the vehicle M.

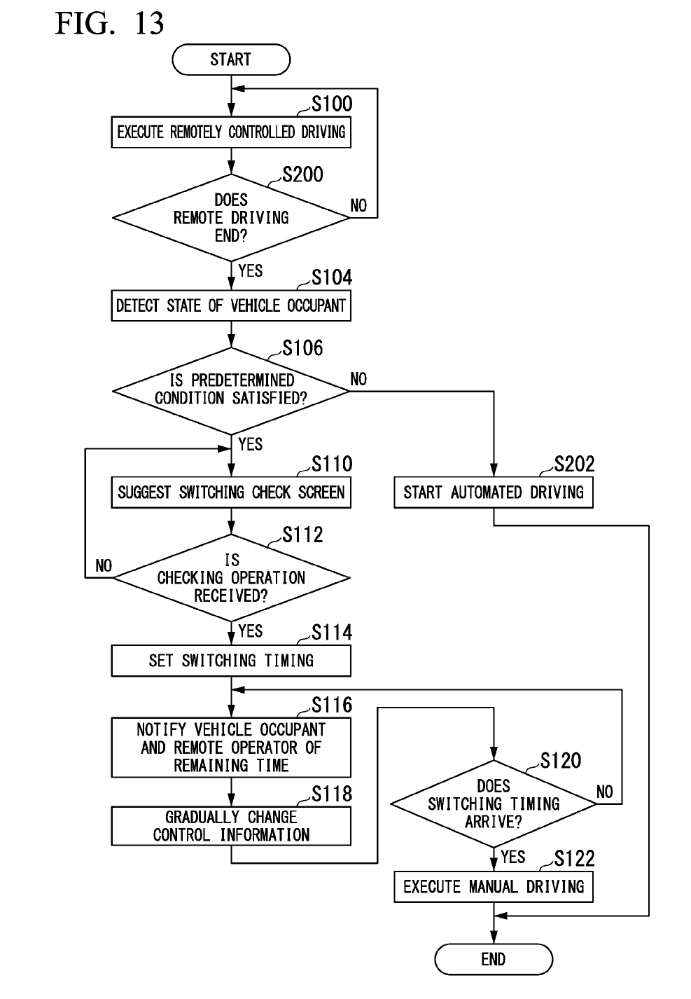

The above-described automated driving control unit 100 may cause the first controller 120 to execute the automated driving when the remotely controlled driving ends and the occupant state of the vehicle M detected by the detector does not satisfy the predetermined condition. FIG. 13 is a flowchart illustrating an example of a flow of a process of ending execution of the remote driving and starting execution of the automated driving or the manual driving. In the flowchart, the same reference numerals are given to the same processes as those of FIG. 7 and the detailed description will be omitted. The vehicle M determines whether the execution of the remotely controlled driving ends, for example, for each predetermined time, while the remote driving is executed (step S200). For example, when a communication state between the communication device 20 and the remote operation management facility 300 is disconnected and thus a period in which the control information is not transmitted from the remote operation management facility 300 exceeds a predetermined period, the switching controller 161 determines that the execution of the remotely controlled driving ends.

When the switching controller 161 determines that the execution of the automated driving does not end, the switching controller 161 continues to execute the remotely controlled driving. The switching controller 161 detects a state of the occupant of the vehicle M when the execution of the automated driving ends (step S104). Subsequently, the switching controller 161 determines whether the occupant state of the vehicle M detected in step S104 satisfies a predetermined condition (step S106). When the predetermined condition is satisfied, the switching controller 161 causes the process to move to the process subsequent to step S110 and starts executing the manual driving. When the predetermined condition is not satisfied, the switching controller 161 requests the first controller 120 to start executing the automated driving. Thus, the first controller 120 starts the automated driving (step S200).

[Remote Operation from Vehicle]

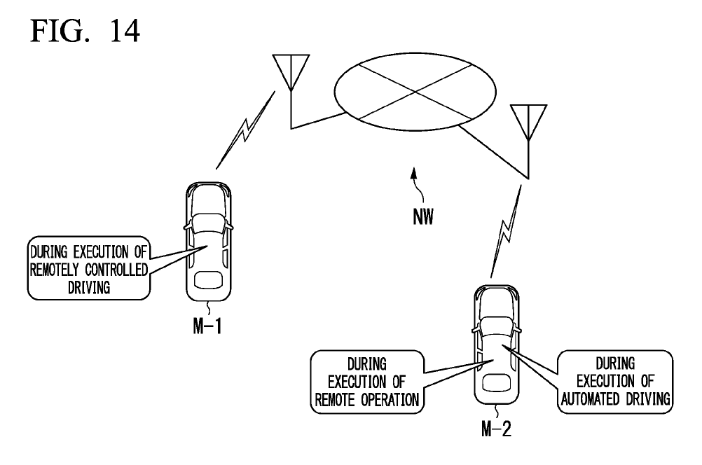

A remote operation of the vehicle may be executed by an occupant of the vehicle during the automated driving rather than the remote operation device 320 of the remote operation management facility 300. FIG. 14 is a diagram conceptually illustrating a form in which a remote operation is executed by an occupant of a vehicle. In the drawing, a vehicle M-1 is a vehicle during execution of the above-described remotely controlled driving. A vehicle M-2 is a vehicle in which a driving operator is in a free state since automated driving is executed and the driving operator originally used for a driving operation of the vehicle can be used as a driving operator of a remote operation. In this case, in the vehicle M-2, for example, an image received from the vehicle M-1 is displayed on a head-up display (HUD) or the like and the remote operation is executed in an environment in which the occupant feels as if the occupant is driving the vehicle M-1. Even in this case, the remote operation management facility 300 may intervene between the vehicles M-1 and M-2. That is, a remote operation request may first be transmitted to the remote operation management facility 300 and may be transmitted to the vehicle M during the automated driving by the remote operation management facility 300.

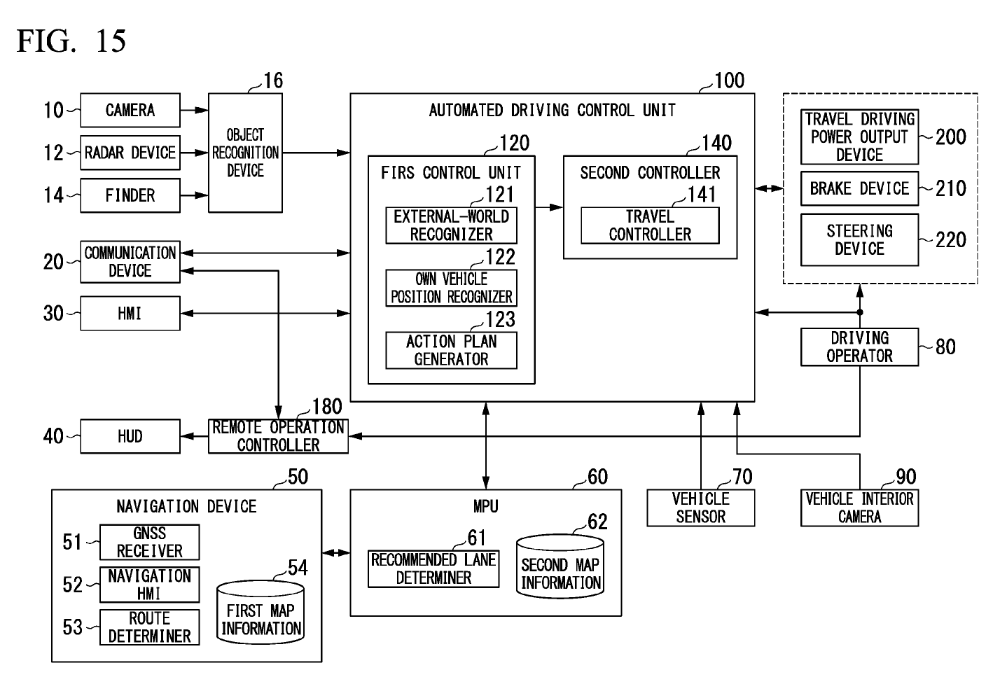

FIG. 15 is a diagram illustrating an example of a configuration mounted in the vehicle M executing the remote operation. In the drawing, common reference numerals are given to units that have similar functions to the functions described with reference to FIG. 2. That is, the automated driving control unit 100 mounted on the vehicle M that executes a remote operation may have similar functions to those of the above-described automated driving control unit 100.

On the vehicle M that executes a remote operation, an HUD 40 and a remote operation controller 180 are mounted in addition to the configuration illustrated in FIG. 2. The remote operation controller 180 causes the HUD 40 to display an image captured by the camera 10 of the vehicle M that executes the remote operation, or the like and generates control information to be transmitted to the vehicle M that executes the remote operation based on an operation amount input from the driving operator 80 which is in a free state.

The vehicle M that executes a remotely controlled driving and the vehicle M that executes a remote operation will be described separately, but the vehicle M may be configured to have both the functions. That is, when it is necessary to execute the remotely controlled driving, the vehicle M may be able to execute the remotely controlled driving and execute a remote operation in response to a request from another vehicle during automated driving.

According to the above-described vehicle control system 1, when the remotely controlled driving is executed and the occupant state of the vehicle M satisfies the predetermined condition, the switching from the remotely controlled driving to the manual driving is performed. Therefore, it is possible to suppress a burden on the occupant of the vehicle M.

Further, according to the vehicle control system 1, when the occupant state of the vehicle M does not satisfy the predetermined condition, the automated driving is executed by the automated driving control unit 100. Therefore, it is possible to further suppress a burden on the occupant of the vehicle M.

According to the vehicle control system 1, since a state in which the manual driving is possible is determined based on an operation of the occupant of the vehicle M and the switching from the remotely controlled driving to the manual driving is performed, it is possible to suppress the switching from the remotely controlled driving to the manual driving in a state in which the manual driving is difficult. Thus, it is possible to reduce a burden on the occupant of the vehicle M.

Further, according to the vehicle control system 1, when the remotely controlled driving is executed, an image indicating that the vehicle M is executing the remotely controlled driving is suggested. When the switching from the remotely controlled driving to the manual driving is necessary, an image for checking the switching from the remotely controlled driving to the manual driving is suggested. When an operation of checking the switching from the remotely controlled driving to the manual driving is received, it is determined that the occupant state of the vehicle M satisfies the predetermined condition. Therefore, the occupant of the vehicle M can check the switching from the remotely controlled driving to the manual driving.

Further, according to the vehicle control system 1, since the period until the switching timing arrives is suggested, the switching from the remotely controlled driving to the manual driving can be smoothly executed. Therefore, it is possible to reduce a burden on the occupant of the vehicle.

Further, according to the vehicle control system 1, since the information indicating the switching timing or the information indicating the period until the switching timing arrives is transmitted to the remote operation management facility 300, the switching from the remotely controlled driving to the manual driving can be smoothly executed. Thus, it is possible to reduce a burden on the occupant of the vehicle.

Further, according to the vehicle control system 1, since a control amount indicating the control information during the period until the switching timing arrives is reduced gradually, it is possible to execute a driving operation on the driving operator 80 during the switching from the remotely controlled driving to the manual driving. Thus, according to the vehicle control system 1, when the switching timing arrives, it is possible to avoid abrupt end of travel of the vehicle M based on the control information. Thus, it is possible to reduce a burden on the occupant of the vehicle M.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### REFERENCE SIGNS LIST

1 Vehicle control system

30 HMI

31 Display

32 Input unit

40 HUD

60 MPU

61 Recommended lane determiner

70 Vehicle sensor

100 Automated driving control unit

120 First controller

140 Second controller

160 Remotely controlled driving controller

161 Switching controller

162 Notification unit

180 Remote operation controller

300 Remote operation management facility

310 General control device

312 Remote operator list

320 Remote operation device

322 Speaker

323 Sheet

324 Steering wheel

325 Pedals

330 Remote operation controller

What is claim is:

1. A vehicle control device comprising:
an acquisitor configured to acquire a situation outside a vehicle;
a driving operator configured to execute an operation for manual driving by an occupant of the vehicle;
a detector configured to detect a state of the occupant of the vehicle;
a manual driving controller configured to execute the manual driving to cause the vehicle to travel based on an operation received by the driving operator;
a communicator configured to communicate with a facility outside the vehicle and transmit the situation outside the vehicle acquired by the acquisitor to the facility outside the vehicle;
a remotely controlled driving controller configured to execute remotely controlled driving to cause the vehicle to travel based on control information received from the facility outside the vehicle; and
a switching controller configured to switch from the remotely controlled driving to the manual driving when the remotely controlled driving is executed by the remotely controlled driving controller and a state of the occupant of the vehicle detected by the detector satisfies a predetermined condition.

2. The vehicle control device according to claim 1, further comprising:
an automated driving control unit configured to execute automated driving to automatically control at least one of acceleration or deceleration and steering of the vehicle,
wherein, when the remotely controlled driving is ended by the remotely controlled driving controller and the occupant state of the vehicle detected by the detector does not satisfy the predetermined condition, the automated driving control unit executes the automated driving.

3. The vehicle control device according to claim 1,
wherein the predetermined condition is a condition that the occupant state of the vehicle is a state in which the manual driving is executable.

4. The vehicle control device according to claim 2,
wherein the detector acquires an image obtained by imaging the occupant of the vehicle, and
wherein the switching controller determines whether the occupant state of the vehicle is a state in which the manual driving is executable based on the image obtained by imaging the occupant of the vehicle.

5. The vehicle control device according to claim 2,
wherein the detector acquires an operation state in the driving operator, and
wherein, based on the operation state in the driving operator, the switching controller determines whether the manual driving is executable based on an operation of the occupant of the vehicle.

6. The vehicle control device according to claim 1, further comprising:
a suggestion unit configured to suggest information;
a notification unit configured to cause the suggestion unit to suggest information indicating that the vehicle is executing the remotely controlled driving when the remotely controlled driving controller executes the remotely controlled driving and cause the suggestion unit to suggest information for checking switching from the remotely controlled driving to the manual driving when the switching from the remotely controlled driving to the manual driving is necessary; and
an input unit configured to receive an input operation by the occupant of the vehicle,
wherein the switching controller determines that the occupant state of the vehicle satisfies the predetermined condition when the input unit receives an operation of checking the switching from the remotely controlled driving to the manual driving.

7. The vehicle control device according to claim 1,
wherein the switching controller sets a timing of the switching from the remotely controlled driving to the manual driving, and
wherein the vehicle control device further comprises:
a suggestion unit configured to suggest information; and
a notification unit configured to cause the suggestion unit to suggest a period until the timing arrives.

8. The vehicle control device according to claim 6, wherein the switching controller causes the communicator to transmit information indicating the timing or information indicating a period until the timing arrives to the facility outside the vehicle.

9. The vehicle control device according to claim 6, wherein the remotely controlled driving controller reduces a control amount indicated by the control information gradually during a period until the timing arrives.

10. A vehicle control system comprising:
the vehicle control device according to claim 1; and
the facility outside the vehicle.

11. A vehicle control method causing a computer to:
acquire a situation outside a vehicle;
transmit the acquired situation outside the vehicle to a facility outside the vehicle;
execute remotely controlled driving to cause the vehicle to travel based on control information received from the facility outside the vehicle;
detect a state of an occupant of the vehicle when the remotely controlled driving is executed; and
execute manual driving to cause the vehicle to travel based on an operation received by a driving operator in which an operation is executed for the manual driving by the occupant of the vehicle from the remotely controlled driving when the detected occupant state of the vehicle satisfies a predetermined condition.

12. A computer-readable non-transitory storage medium storing a vehicle control program causing a computer to:
acquire a situation outside a vehicle;
transmit the acquired situation outside the vehicle to a facility outside the vehicle;
execute remotely controlled driving to cause the vehicle to travel based on control information received from the facility outside the vehicle;
detect a state of an occupant of the vehicle when the remotely controlled driving is executed; and
execute manual driving to cause the vehicle to travel based on an operation received by a driving operator in which an operation is executed for the manual driving by the occupant of the vehicle from the remotely controlled driving when the detected occupant state of the vehicle satisfies a predetermined condition.
